(19) United States
(12) Patent Application Publication
(10) Pub. No.: US 2014/0365249 A1
(43) Pub. Date: Dec. 11, 2014

(54) SYSTEM AND METHOD FOR PROVIDING LOCATION BASED SOCIAL DINING MATCHING

(71) Applicant: Lawrence Ditoro, Mountain View, CA (US)

(72) Inventor: Lawrence Ditoro, Mountain View, CA (US)

(21) Appl. No.: 13/912,249

(22) Filed: Jun. 7, 2013

(51) Int. Cl. G06Q 10/02; G06Q 50/00

(52) U.S. Cl. CPC G06Q 10/02; G06Q 50/01
USPC 705/5

(57) ABSTRACT

The present invention generally relates to computer and web-based dining services. Specifically, this invention relates to systems and methods for matching users for a social dining experience, utilizing location based services and filtering technologies as well as restaurant availability services and other criteria.

### CROSS-REFERENCE TO RELATED APPLICATIONS

This application claims the benefit of the following provisional application, each of which is hereby incorporated by reference in its entirety: U.S. Pat. App. No. 61/825,887 filed on May 21, 2013.

### FIELD OF THE INVENTION

The present invention generally relates to computer and web-based dining services. Specifically, this invention relates to systems and methods for matching users for a social dining experience, utilizing location based services and filtering technologies as well as restaurant availability services and other criteria.

### BACKGROUND

As our world becomes more and more connected via web-based systems, many everyday tasks are becoming streamlined and integrated with sophisticated technology. From dating to shopping, many of our experiences are being optimized through mobile and web-based technologies.

However, even with these advances in technology, there are numerous fields that are left unattended or otherwise ignored by current technology. It is an aspect of the present invention to cure current deficiencies in at least one specific area, that being social dining experiences and the creation and management thereof

Currently, there are systems that allow you to search and reserve tables at numerous restaurants without having to call or otherwise contact the restaurant directly to make a reservation. However, these systems are mostly dedicated to filling tables in restaurants that make their inventory available to the systems. Other than booking a table with a set number of seats for a specific time, these systems do not provide any means for matching users up or otherwise generating invites to other potential attendees. Further, most of these systems are keyword search based and do not utilize any location based services to identify the location of restaurants or potential dining partners in a user's area or general vicinity.

Finally, while there are matchmaking services that will set a person up on a lunch date, dinner date or something similar, these services are generally run by individuals who will receive requests from users and match them manually based on preferences and availability. These systems do not utilize location based services or other technological means to match individuals, identify restaurants in the area and book the dining experience automatically.

Therefore, there is need in the art for a computer and web-based marketplace system and method for matching users for a social dining experience, utilizing location based services and filtering technologies as well as restaurant availability services and other criteria. These and other features and advantages of the present invention will be explained and will become obvious to one skilled in the art through the summary of the invention that follows.

### SUMMARY OF THE INVENTION

Accordingly, it is an aspect of the present invention to provide a system and method for matching users for a social dining experience, utilizing location based services and filtering technologies as well as restaurant availability services and other criteria. In a preferred embodiment, the system and method matches a group of two or more individuals based on multiple criteria and coordinates a dining experience amongst the group.

According to an embodiment of the present invention, a system for providing a social dining experience, the system comprising: a matching module, comprising computer-executable code stored in non-volatile memory, a reservation module comprising computer-executable code stored in non-volatile memory, a processor, and a communications means, wherein the matching module, the reservation module, the processor, and the communications means are operably connected and are configured to: receive a dining event request from an initiating user, wherein the dining event request comprises specific criteria related to a potential dining event; generate a dining event based at least in part on the specific criteria; identify one or more potential dining event attendees based at least in part on the specific criteria; transmit one or more notifications regarding the dining event to each of the one or more potential dining event attendees; receive one or more confirmations from the one or more potential dining event attendees; retrieve reservation contact information related to a dining venue; generate a dining reservation with the dining venue utilizing the reservation contact information, wherein the dining reservation comprises reservation criteria related to a dining time and number of confirmed attendees; and transmit one or more dining event confirmations to one or more of the group comprising the initiating user and the one or more potential dining event attendees.

According to an embodiment of the present invention, the dining reservation further comprises one or more specific criteria selected from the group comprising cuisine selection, restaurant style, availability of alcohol, size of restaurant, availability, dining time, location and proximity.

According to an embodiment of the present invention, the reservation module, the processor, and the communications means are further configured to modify the dining reservation based upon receipt of an update from one or more of the group comprising the initiating user and the one or more potential dining event attendees.

According to an embodiment of the present invention, the modification of the dining reservation comprises the increasing of a reserved party size.

According to an embodiment of the present invention, the modification of the dining reservation comprises the decrease of a reserved party size.

According to an embodiment of the present invention, the modification of the dining reservation comprises cancelling a first reservation at a first dining event location and entering a second reservation at a second dining event location.

According to an embodiment of the present invention, the modification of the dining reservation comprises providing reservation criteria to a first dining event location.

According to an embodiment of the present invention, a method for providing a social dining experience includes the steps of: receiving a dining event request from an initiating user, wherein the dining event request comprises specific criteria related to a potential dining event; generating a dining event based at least in part on the specific criteria; identifying one or more potential dining event attendees based at least in part on the specific criteria; transmitting one or more notifications regarding the dining event to each of the one or more potential dining event attendees; receiving one or more confirmations from the one or more potential dining event attendees; retrieving reservation contact information related to a dining venue; generating a dining reservation with the dining venue utilizing the reservation contact information, wherein the dining reservation comprises reservation criteria related to a dining time and number of confirmed attendees; and transmitting one or more dining event confirmations to one or more of the group comprising the initiating user and the one or more potential dining event attendees.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a network schematic of a system, in accordance with an embodiment of the present invention;

FIG. 4 illustrates a schematic of a location based social dining matching module, in accordance with an embodiment of the present invention; and

FIG. 5 is a process flow of an exemplary method in accordance with embodiments of the present invention.

### DETAILED SPECIFICATION

The present invention generally relates to computer and web-based dining services. Specifically, this invention relates to systems and methods for matching users for a social dining experience, utilizing location based services and filtering technologies as well as restaurant availability services and other criteria.

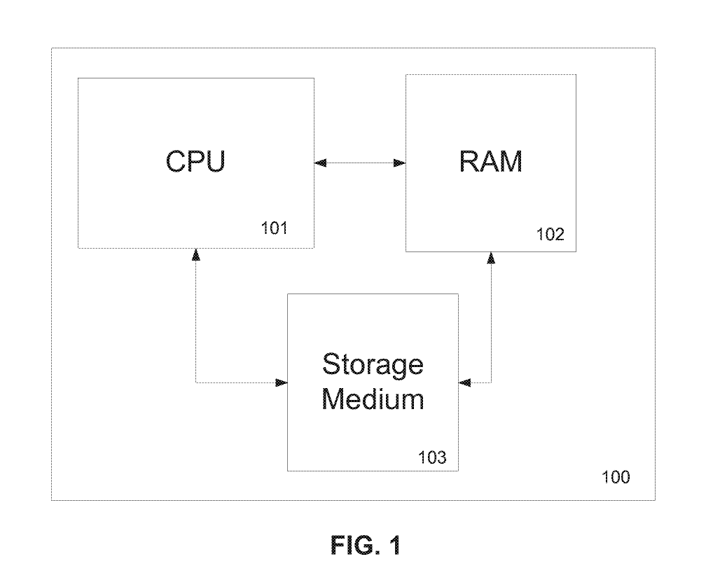

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

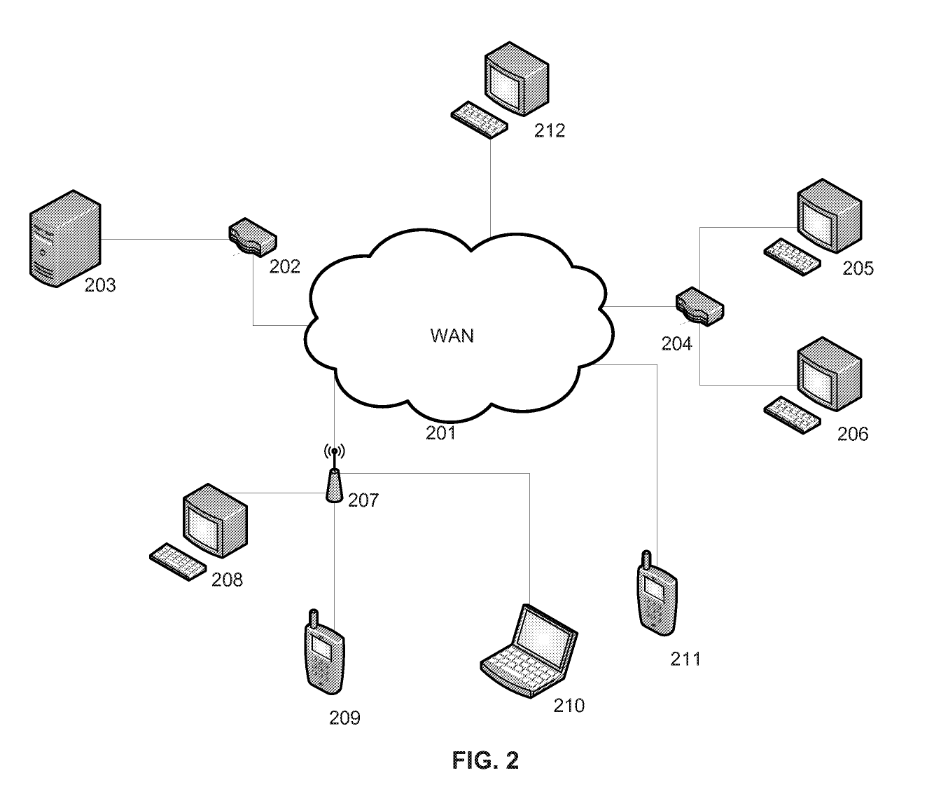

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

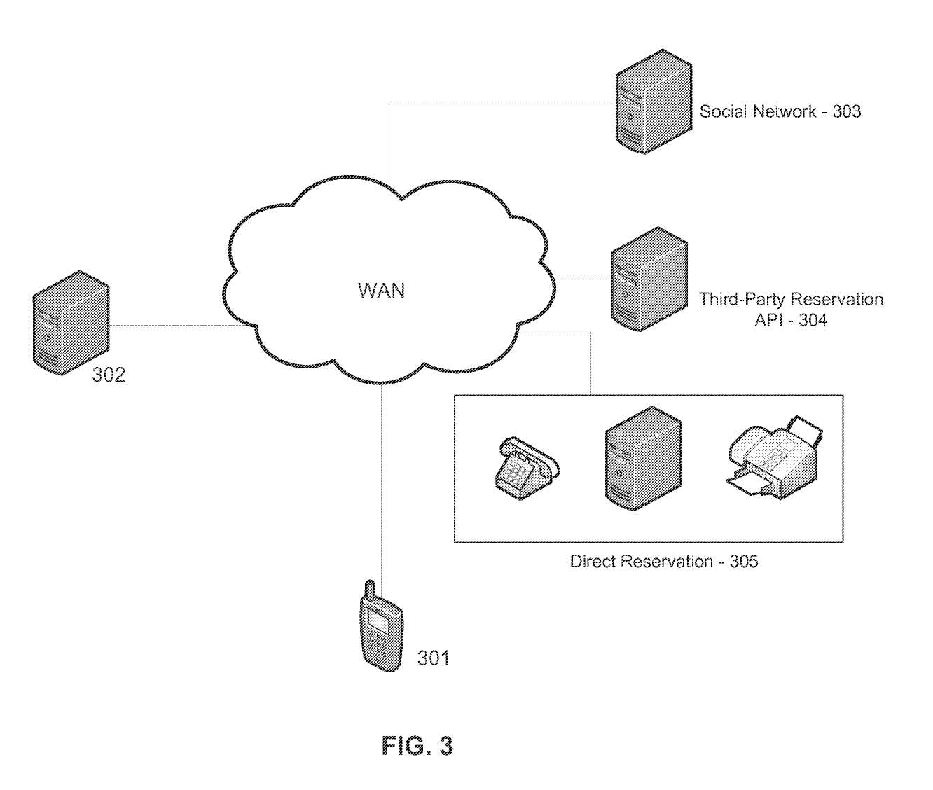

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of a social network 303, a third party reservation API or other third party reservation system 304, one or more direct reservation systems 305 (e.g., restaurant's booking system, facsimile line, phone line) or any combination thereof. One of ordinary skill in the art would appreciate how accessing one or more third-party systems could augment the ability of the system described herein, and embodiments of the present invention are contemplated for use with any third-party system.

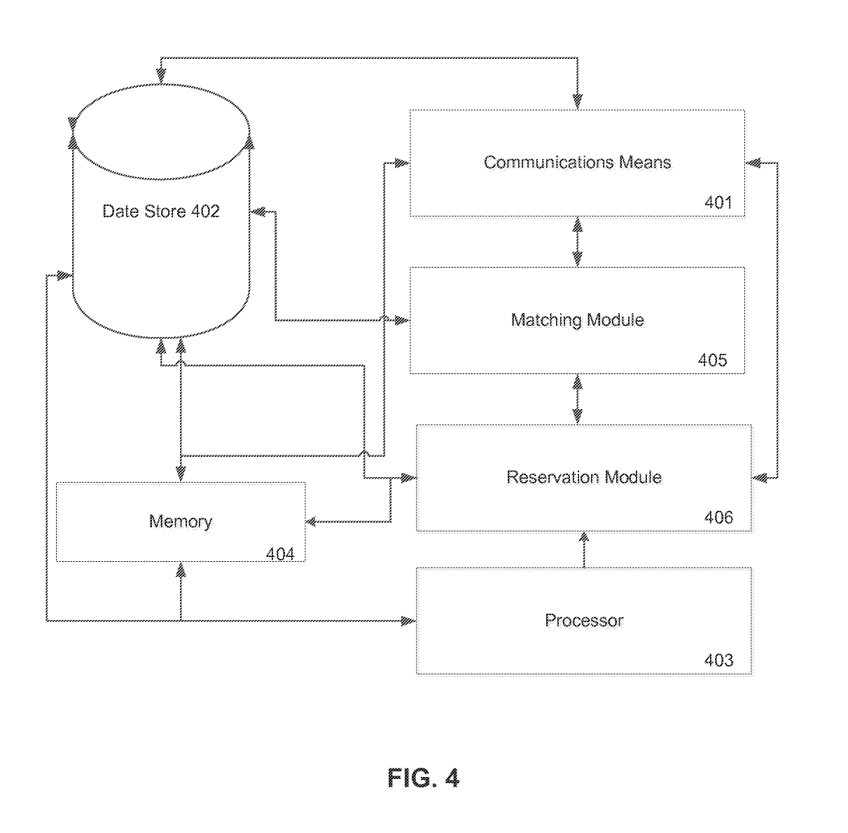

Turning to FIG. 4, according to an embodiment of the present invention, a system for providing a location based social dining matching is comprised of one or more communications means 401, one or more data stores 402, a processor 403, memory 404, a matching module 405 and a reservation module 406. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the matching module is configured to analyze, process and communicate information related to the matching and organization of dining event attendees. The matching module may further be configured to analyze process and communicate information from and between one or more third-party systems to assist or otherwise improve matching dining event attendees to reservations and events. Third-party systems may include, but are not limited to, social networks, professional networks and any other third-party network. In a preferred embodiment, the accessibility to these third-party systems may be by way of API or other programmatic communications means.

According to an embodiment of the present invention, the reservation module is configured to analyze process and communicate information related to organizing, placing and amending reservations for dining events. The reservation module may be configured to analyze process and communicate information from and between one or more third-party systems to assist or otherwise improve the reservation and formation of a dining event process. Third-party systems may include, but are not limited to, third-party reservation systems, direct contact means with restaurants (e.g., automated phone systems, automated facsimile systems, automated reservation systems).

According to an embodiment of the present invention, the matching module, reservation module and communication module are configured to work in conjunction with the underlying hardware of a web-based system (e.g., processor(s), memory, storage mediums, databases) in order to provide the systems and methods described herein. In a preferred embodiment of the present invention, each of the matching module, reservation module and communication module are communicatively connected to one another and the underlying system hardware. One of ordinary skill in the art would appreciate that while the description herein may place certain functionality in one or more of the matching module, the communications module or the reservation module, other embodiments may place the various functions in fewer or additional modules or, alternatively or in conjunction with the foregoing, place the functionality in different sets amongst the various modules. Each of these embodiments is contemplated by the present invention.

According to an embodiment of the present invention, the system may be configured to allow users to generate and/or schedule dining events at local restaurants based on specific criteria identified by the initiating user. Specific criteria may include, but is not limited to, cuisine type, restaurant style, availability of alcohol (e.g., bring your own, full bar, no alcohol), size of restaurant, size of desired dining party, availability, dining time, location, proximity to one or more users, or any combination thereof. One of ordinary skill in the art would appreciate that there are numerous types of specific criteria that could be utilized with embodiments of the present invention, and embodiments of the present invention are contemplated for use with any type of specific criteria.

In preferred embodiments of the present invention, the system may be configured to utilize location based information as part of the specific criteria. Location based information may be derived from one or more location services (e.g., IP protocol, global positioning system (GPS), cellular triangulation, cell tower identification, near-field communication (NFC), last known location). The location based information may be utilized by the system in analysis and recommendation of restaurants, dining events, timing and location/availability of other users/friends. This information may be compiled amongst all users or a subset thereof and utilized in order to make specific recommendations and dining events, including reserving appropriate table space or other space at a selected/identified restaurant or other dining venue (e.g., food truck, café, bar, event hall).

According to an embodiment of the present invention, once a dining event is requested/generated, the system may be configured to identify potential dining event attendees. Potential dining event attendees are users of the system or users of third-party systems communicatively connected to the system (e.g., social networks) that would be likely attendees to the generated dining event. The scope of potential dining event attendees may be set by the initiating user. For instance, an initiating user may wish to only dine with his/her friends or relatives. In other examples, an initiating user may wish to dine with any active users in the general vicinity (e.g., within 5 miles, within 10 miles, within 1 mile, within 100 yards). In other examples, an initiating user may only wish to dine with active users that are friends of the initiating user and those friends that are within 1 mile and have expressed interest in Thai food. From the above examples it is clear that the scope can be anywhere from extremely broad to extremely refined, depending on the preferences of the initiating user.

By allowing the initiating user to define the scope of the potential dining event attendees, the initiating user is provided the ability to create the appropriate experience they desire. This allows the initiating user to create a dining experience that may be anywhere from a quiet affair with friends to a networking opportunity with numerous strangers or acquaintances.

According to an embodiment of the present invention, the system may allow an initiating user to invite individuals that are not friends or otherwise acquainted with the initiating user. In certain embodiments, the initiating user may be able to invite others who are actively utilizing the system and searching for dining events or passively waiting for dining event invitation. In other embodiments, the initiating user may be able to send out a general invite for anyone in a specific area or based on specific criteria (e.g., individuals who speak Italian, individuals of certain political views, individuals of certain religious views). One of ordinary skill in the art would appreciate that there are numerous types of specific criteria that could be used, and embodiments of the present invention are contemplated for use with any type of specific criteria.

According to an embodiment of the present invention, the system may be configured to make, update and cancel reservations as appropriate and necessary for a dining event. For instance, if a user wishes to have a casual dining experience with a selected list of friends, the system may select a particular restaurant and make initial reservations based on an anticipated number of dining event attendees. If the number of confirmed dining event attendees (i.e., attendees who have confirmed attendance for a specific dining event) exceeds that anticipated number or if the initial location/restaurant for the dining event cannot provide a reservation based on the new number of confirmed dining event attendees, the system can automatically cancel the initial reservation and search and make reservations at an appropriate replacement location that can handle the update. In conjunction with this, the system can be configured to provide updated event information to confirmed dining event attendees (e.g., via SMS, via e-mail, via facsimile, via automated voice message/calling). This may also work in the opposite direction, where an event originally has a large number of confirmed attendees that experiences a reduction in that number that no longer warrants a large reserved area and must be moved to a smaller venue/reservation. Similarly, reservations may be updated in real time based on any number of other criteria, such as time, location, flexibility, required attire, cuisine type, reviews/ratings or any combination thereof.

### Exemplary Embodiment

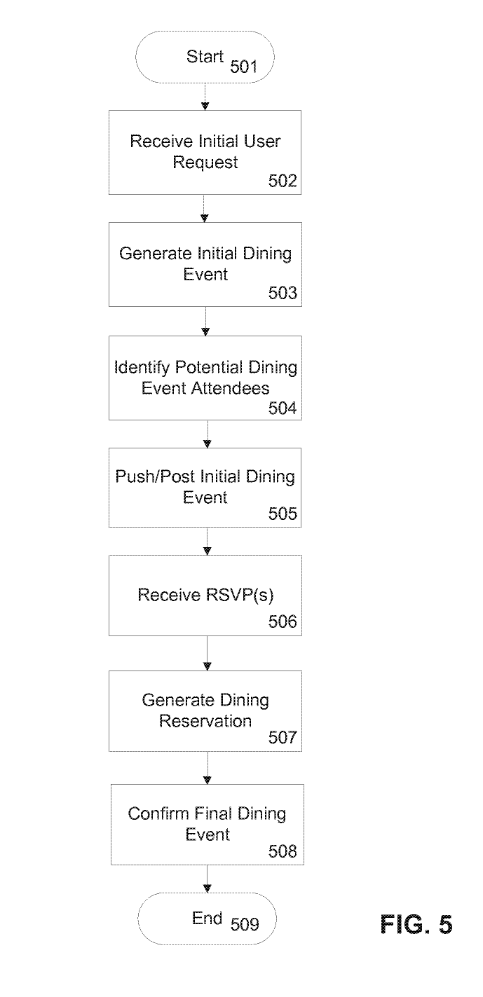

Turning now to FIG. 5, an exemplary method in accordance with an embodiment of the present invention is shown. In this method, the process starts at step 501 with an initiating user contacting the system for provision of a dining event. At step 502, the system receives the request from the initiating user and processes the initial information received. In certain embodiments, the initial information could be provided in any number of formats, including, but not limited to, text, audio (e.g., voice recording), mixed format, data or any combination thereof. The system may be configured to and able to process the initial information, and all other information received from users, into a format usable by the system. This may include, but is not limited to, voice recognition and processing means.

At step 503, the system has parsed the information received and generates the initial dining event request. This may include provisioning a request to one or more restaurants for availability based on the specific criteria provided by the initiating user.

At step 504, the system identifies potential dining event attendees based on the specific criteria provided by the initiating user. In certain embodiments, especially where the initiating user is generating an event without a set guest list (i.e., potentially inviting strangers/acquaintances), the initiating user may be able to approve/disprove of each specific potential dining event attendee or groups/subsets of potential dining event attendees.

At step 505, the potential dining event attendees have been identified and the system contacts each of the potential dining event attendees regarding the dining event. In certain embodiments, the system may be configured to allow a window of time for response. If a potential dining event attendee does not respond before this window closes, they are assumed to not be attending the event, allowing for reservations to be made and confirmed prior to a dining event.

At step 506, the system receives one or more RSVPs from the potential dining event attendees. The system may be configured to store and confirm the RSVPs and the RSVPs may also include additional information, such as comments, dining requirements (e.g., gluten free, vegetarian) or selection of cuisine choice where required (e.g., Pre Fixe menus with options, deserts/meals that require ordering prior to arrival).

At step 507, as the dining event approaches, the system makes/confirms the reservation with the restaurant or other dining venue. In certain cases, where an original reservation was made and the number of confirmed attendees matches the original reservation, no confirmation may need to be made. However, for accuracy and completeness it may be appropriate to confirm reservations, even where no change is required. Upon confirmation, the system may confirm the final dining event with the initiating user, the confirmed attendees, or any subset thereof (step 508). The process then terminates at step 509.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing a social dining experience, the system comprising:
a matching module, comprising computer-executable code stored in non-volatile memory,
a reservation module comprising computer-executable code stored in non-volatile memory,
a processor, and
a communications means,
wherein said matching module, said reservation module, said processor, and said communications means are operably connected and are configured to:
receive a dining event request from an initiating user, wherein said dining event request comprises specific criteria related to a potential dining event;
generate a dining event based at least in part on said specific criteria;
identify one or more potential dining event attendees based at least in part on said specific criteria;
transmit one or more notifications regarding said dining event to each of said one or more potential dining event attendees;
receive one or more confirmations from said one or more potential dining event attendees;
retrieve reservation contact information related to a dining venue;
generate a dining reservation with said dining venue utilizing said reservation contact information, wherein said dining reservation comprises reservation criteria related to a dining time and number of confirmed attendees; and
transmit one or more dining event confirmations to one or more of the group comprising the initiating user and the one or more potential dining event attendees.

2. The system of claim 1, wherein said dining reservation further comprises one or more specific criteria selected from the group comprising cuisine selection, restaurant style, availability of alcohol, size of restaurant, availability, dining time, location and proximity.

3. The system of claim 1, wherein said matching module, said reservation module, said processor, and said communications means are further configured to modify said dining reservation based upon receipt of an update from one or more of the group comprising said initiating user and said one or more potential dining event attendees.

4. The system of claim 3, wherein said modification of said dining reservation comprises the increasing of a reserved party size.

5. The system of claim 3, wherein said modification of said dining reservation comprises the decrease of a reserved party size.

6. The system of claim 3, wherein said modification of said dining reservation comprises cancelling a first reservation at a first dining event location and entering a second reservation at a second dining event location.

7. The system of claim 3, wherein said modification of said dining reservation comprises providing reservation criteria to a first dining event location.

8. A method for providing a social dining experience, the method comprising the steps of:
receiving a dining event request from an initiating user, wherein said dining event request comprises specific criteria related to a potential dining event;
generating a dining event based at least in part on said specific criteria;
identifying one or more potential dining event attendees based at least in part on said specific criteria;
transmitting one or more notifications regarding said dining event to each of said one or more potential dining event attendees;
receiving one or more confirmations from said one or more potential dining event attendees;
retrieving reservation contact information related to a dining venue;
generating a dining reservation with said dining venue utilizing said reservation contact information, wherein said dining reservation comprises reservation criteria related to a dining time and number of confirmed attendees; and
transmitting one or more dining event confirmations to one or more of the group comprising the initiating user and the one or more potential dining event attendees.

9. The method of claim 8, wherein said dining reservation further comprises one or more specific criteria selected from the group comprising cuisine selection, restaurant style, availability of alcohol, size of restaurant, availability, dining time, location and proximity.

10. The method of claim 8, wherein said matching module, said reservation module, said processor, and said communications means are further configured to modify said dining reservation based upon receipt of an update from one or more of the group comprising said initiating user and said one or more potential dining event attendees.

11. The method of claim 10, wherein said modification of said dining reservation comprises the increasing of a reserved party size.

12. The method of claim 10, wherein said modification of said dining reservation comprises the decrease of a reserved party size.

13. The method of claim 10, wherein said modification of said dining reservation comprises cancelling a first reservation at a first dining event location and entering a second reservation at a second dining event location.

14. The method of claim 10, wherein said modification of said dining reservation comprises providing reservation criteria to a first dining event location.
